(19) United States
(12) Patent Application Publication
(10) Pub. No.: US 2003/0079519 A1
(43) Pub. Date: May 1, 2003

(54) Apparatus and method for alerting a user of the presence of a target gas

(76) Inventors: Charles Wilkinson, Port Jefferson, NY (US); Stuart Linzer, Seaford, NY (US); Mark Sjogren, Ft. Salonga, NY (US)

Correspondence Address: Leopold Presser, Scully, Scott, Murphy & Presser, 400 Garden City Plaza, Garden City, NY, 11530, US

(21) Appl. No.: 09/999,108

(22) Filed: Oct. 31, 2001

(51) Int. Cl. G01N 9/00

(52) U.S. Cl. 73/23.2

(57) ABSTRACT

A gas leak detection system and method for detecting the presence of a leaking gas, such as helium. The apparatus consists of a housing containing an extended nozzle with a tip at the end. The housing contains an eccentric motor. The presence of a target gas is detected through a sensing element located in the leak detector, which sends a signal to the CPU. When the amount of the gas leak is over a threshold, the CPU sends a signal to an eccentric motor located in the housing causing the handle of the instrument to vibrate, thereby notifying the user that a leak has been detected. A signal is also preferably sent from the CPU to a light emitting diode (LED), as to visually notify the user as well, and to a speaker to audibly alert the user, both the vibrations and audio alarms can be turned on/off by a switch.

### BACKGROUND OF THE INVENTION

1. Field of the Invention

The present invention relates to gas leak detection, and more specifically, to an apparatus capable of detecting leaks of target gases such as helium, by alerting a user of the presence of the target gas through a tactile response.

2. Prior Art

Generally, products that detect the presence of gas leaks alert the user through visual or audible means, which is usually achieved by an LED or an audible alarm, respectively. The user points the probe at a product at a point where it is likely the target gas is leaking, and has to either hear the alarm, or look back at the leak detector product to which the probe is connected to determine if the visual alarm is activated in order to determine the presence of a gas leak.

Information relevant to attempt to address these problems can be found in U.S. Pat. Nos. 5,388,446 and 5,341,671. However, each of these references suffers from one or more of the following disadvantages: the user is not able to use the sniffer probe in a manner that allows him to detect the presence of a target gas through a tactile means. The problem with an audible alarm is that usually the user will be working in a loud environment, such as on a production line where several leak detectors are being used, and it is often difficult to be able to hear the alarm or even if heard, to know which unit is detecting a leak. With a visual alarm, the problem is that the operator has to keep glancing back and forth from probe tip to the leak detector to see if the visual indicator is activated.

### SUMMARY OF THE INVENTION

Therefore, it is an object of the present invention to provide an apparatus for alerting a user of the presence of a target gas through a tactile means.

Accordingly, an apparatus for alerting a user of a target gas is provided. The apparatus comprises a gas detection means for detecting the target gas and outputting a signal upon the detection of the target gas and vibration generation means for generating a vibration in response to the signal.

The apparatus preferably further comprises a setting means which allows the user to input a predetermined amount of the target gas so the signal is output when the target gas surpasses the predetermined amount input by the user.

The vibration generation means preferably comprises an eccentric motor.

Preferably, the apparatus further comprises an audible alarm means for generating an audible alarm in response to the signal. The audible alarm preferably comprises a speaker. Alternatively or additionally, the apparatus further comprises a visual alarm means for generating a visual alarm in response to the signal. The visual alarm preferably comprises an LED.

Also provided is a method of alerting a user of the presence of a target gas. The method comprises detecting the target gas, outputting a signal upon the detection of the target gas, and generating a vibration in response to the signal.

The method preferably further comprises inputting a setting corresponding to a predetermined amount of target gas so the signal is output when the detected gas surpasses the predetermined amount.

Preferably, the generating step comprises powering an eccentric motor.

The method preferably further comprises generating an audible alarm in response to the signal. The audible alarm is preferably generated by powering a speaker. Alternatively or additionally, the method further comprises generating a visual alarm in response to the signal. The visual alarm is preferably generated by powering an LED.

Still yet provided is a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic representation of a system for carrying out a preferred implementation of the methods of FIG. 2.

FIG. 2 illustrates a flowchart showing the preferred steps of the methods of the present invention.

### DETAILED DESCRIPTION OF THE PREFERRED EMBODIMENT

Although this invention is applicable to numerous and various types of target gases and their detection, it has been found particularly useful in the environment of detecting leaking helium from products that are charged with helium. Therefore, without limiting the applicability of the invention to helium leak detection, the invention will be described in such environment.

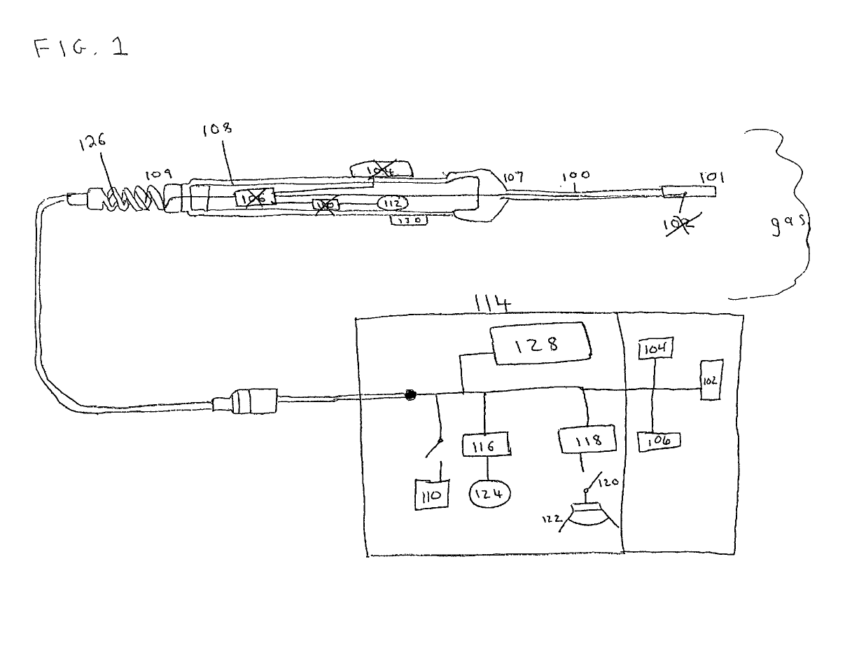

Referring now to FIG. 1, an apparatus for alerting a user of the presence of a target gas through a tactile means is illustrated. Though many different variations of this apparatus are possible, FIG. 1 illustrates a preferred embodiment of the present invention. The apparatus consists of a handle 108, an extended tip 100 at the distal end 107 of the handle, and a flexible cable 126 at the proximal end 109 of the handle. The flexible cable 126 is connected to a leak detector 114, which preferably includes a display monitor 128, a light emitting diode (LED) 124, and a speaker 122, a setting means 104, a central processing unit (CPU) 106, an eccentric motor 112 located inside the handle 108 along with an auto zero button 130. The tip 100 of the instrument contains a filter element 101 to prevent probe clogging.

The handle 108 of the instrument is preferably composed of a plastic housing, having a distal end 107 and a proximal end 109. Situated in the leak detector 114 is a setting means 104, which is preferably an electronic setting for a reject value for the target gas. Enclosed in the housing is an eccentric motor 112, which provides the vibrations generated in the handle 108 of the instrument, alerting the user of the presence of a target gas. Generation of vibrations by eccentric motors is well known to those skilled in the art of vibration generation. An auto zero button 130 is also preferably located on the plastic housing, allowing the user to zero the gas level.

A gas detector 102 is located at the leak detector 114. The gas detector 102 senses the presence of the target gas, such as helium. Gas detectors are well known to those skilled in the art of gas detection.

A flexible cable 126 connects the distal end 109 of the handle 108 to a leak detector 114. Helium leak detectors are generally portable, and have a slot to which a sniffer probe, such as the present invention, connects. Preferably, a display monitor 128, a visual alarm, such as an LED 124, and an audible alarm, such as a speaker 122, CPU 106, setting means 104 are located on the leak detector 114.

First, a reject value is set by a user through the setting means 104 located on the leak detector 114. The reject value allows the user to input a value as a threshold for the amount of helium that is allowed to leak before an alarm is triggered. The gas detector 102 located at the leak detector 114 is where the helium is first detected. This information is relayed to the central processing unit (CPU) 106, which is also connected to the setting means 104. The CPU determines if the level of helium detected by the gas detector 102 is over the threshold set by the user. If the helium level has not exceeded the reject value, the gas detector 102 continues to monitor the presence of helium. If the level of helium detected exceeds the reject value set by the user, the CPU 106 initiates a driver 110 connected to the eccentric motor 112, causing the handle 108 of the instrument to vibrate. This alerts the user holding the handle 108 of the instrument of a leak or the presence of helium.

Once the CPU 106 determines that the level of helium detected exceeds the reject value set by the user, it also preferably initiates a display driver 116 and/or a speaker driver 118 located in the leak detector 114. The handle 108 of the instrument is connected to the leak detector 114 through a cable 126. The display driver 116 powers the LED 124 located on the leak detector 114. The LED 124 also alerts the user of the presence of a helium leak. The speaker driver actuates a speaker 122, alerting the user audibly of the presence of the target gas. The audible alarm/speaker can be shut on/off through a switch 120, located on the leak detector 114. The leak detector also contains a display monitor 128, which gives the user information such as leak rate values, run times, operating voltages/currents and pressures. The gas detector 102 continues to monitor the presence of helium, and once the level of helium is determined by the CPU 106 to be below the reject value set by the user, the vibration/LED/speaker will shut off.

The above description of the present invention is only the preferred embodiment of the invention. Various other combinations are also possible. The visual and audible alarm means, such as an LED and speaker, respectively, may also be located on the handle 108 of the instrument. The vibrations generated to alert a user of the presence of a target gas can be used alone, or with any combination of an audible or visual alarm means. Different gas detectors can be used depending on the type of gas being detected. Preferably, the gas detector 102 is a helium gas detector.

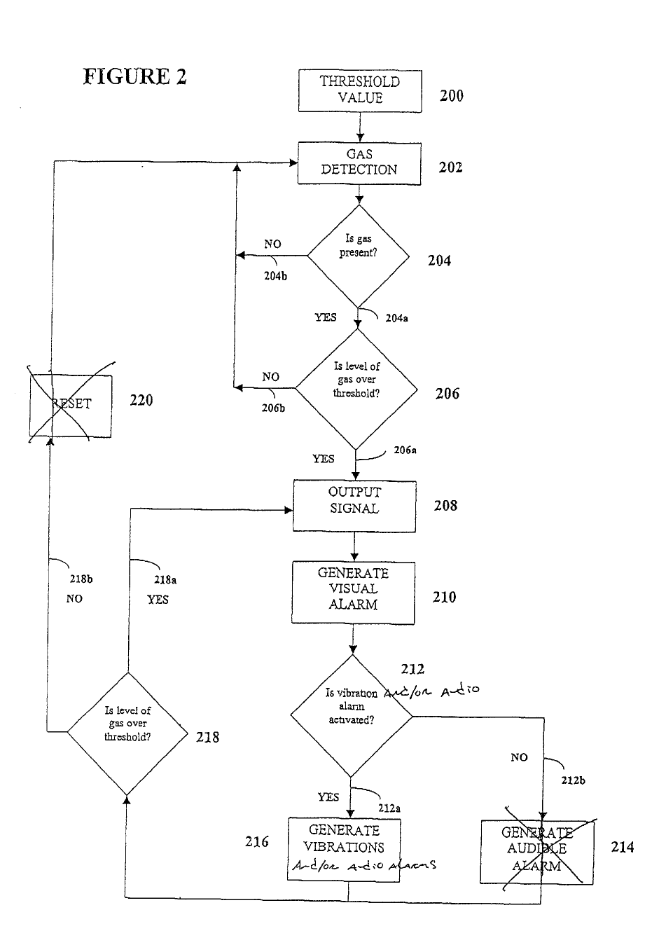

In FIG. 2, a method of alerting a user of the presence of a target gas is illustrated. Though several different variations of this method are possible, the following is the preferred method of gas detection. Initially, a threshold value of a level of a target gas is set at step 200 and target gas detection begins at step 202. At step 204, if the target gas is not present, path 204b is followed and the gas detection at step 202 will continue. If it is determined that the target gas is present at step 204, path 204a is followed to step 206 to determine if the level of the gas is over the threshold. If the level of target gas detected is not over the threshold at step 206, path 206b is followed and gas detection will continue at step 202 to monitor the presence of a target gas. If the level of target gas detected is over the threshold value at step 206, path 206a is followed to step 208, where a signal is output. The signal generates a visual alarm at step 210, and it is then determined whether the vibration and/or audio alarm is activated at step 212. If it is not activated, path 212b is followed. If it is determined the vibration and/or audio alarm is activated at step 212, path 212a is followed and vibrations and/or audio alarm are generated at step 216. The level of the gas will continue to be monitored to determine if the level is still over the threshold at step 218 after the vibrations are generated or the audible alarm is activated. If it is determined the level of the target gas is still over the threshold value at step 218, path 218a is followed and the signal continues to be output. If the level of the gas is not over the threshold at step 218, path 218b is followed.

The present invention provides several advantages that solves the problems with prior art methods. It alerts the user via a tactile means in the handle of the instrument when the target gas is detected. In applications where several leak detectors are on a production line using audio alarms, it is difficult for operators to know which unit is detecting a leak. The present invention eliminates operator confusion and insures that leaks are correctly identified. A second advantage is that the operator can visually concentrate on the probe location and receive an indicator of a leak tactilely, without having to glance back and forth from the probe tip to the leak detector.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An apparatus for alerting a user of the presence of a target gas, the apparatus comprising:
gas detection means for detecting the target gas and outputting a signal upon the detection of the target gas; and
vibration generation means for generating a vibration in response to the signal.

2. The apparatus of claim 1, further comprising a setting means for allowing the user to input a predetermined amount of the target gas, wherein when the target gas surpasses the predetermined amount, the signal is output.

3. The apparatus of claim 1, wherein the vibration generation means comprises an eccentric motor.

4. The apparatus of claim 1, further comprising audible alarm means for generating an audible alarm in response to the signal.

5. The apparatus of claim 4, wherein the audible alarm means comprises a speaker.

6. The apparatus of claim 1, further comprising visual alarm means for generating a visual alarm in response to the signal.

7. The apparatus of claim 6, wherein the visual alarm means is comprises an LED.

8. A method of alerting a user of the presence of a target gas, the method comprising:
detecting the target gas;
outputting a signal upon detecting the target gas; and
generating a vibration in response to the signal.

9. The method of claim 8, further comprising inputting a setting corresponding to a predetermined amount of target gas, wherein when the detected gas surpasses the predetermined amount, the signal is output.

10. The method of claim 8, wherein the generating step comprises powering an eccentric motor.

11. The method of claim 8, further comprising generating an audible alarm in response to the signal.

12. The method of claim 11, wherein the audible alarm is generated by powering a speaker.

13. The method of claim 8, further comprising generating a visual alarm in response to the signal.

14. The method of claim 13, wherein the visual alarm is generated by powering an LED.

15. A computer product embodied in a computer-readable medium for gas leak detection, the computer program product comprising:
computer readable program code means for detecting the target gas and outputting a signal upon the detection of the target gas; and
computer readable program code means for generating a vibration in response to the signal.

16. A program storage device readable by machine, tangibly embodying a program of instructions executable by the machine to perform method steps for gas leak detection, the method comprising:
detecting the target gas;
outputting a signal upon detecting the target gas; and
generating a vibration in response to the signal.
